(19) United States
(12) Patent Application Publication
(10) Pub. No.: US 2014/0048741 A1
(43) Pub. Date: Feb. 20, 2014

(54) FILTRATION MEDIA

(71) Applicants: Richard A. Prince, Westfield, CT (US); John L. Pulek, Cheshire, CT (US); Robert Gieger, Guilford, CT (US)

(72) Inventors: Richard A. Prince, Westfield, CT (US); John L. Pulek, Cheshire, CT (US); Robert Gieger, Guilford, CT (US)

(73) Assignee: 3M Innovative Properties Company, St. Paul, MN (US)

(21) Appl. No.: 14/003,542

(22) PCT Filed: Mar. 2, 2012
(86) PCT No.: PCT/US12/27492

§ 371 Date: Oct. 30, 2013

Related U.S. Application Data
(60) Provisional application No. 61/473,415, filed on Apr. 8, 2011.
(60) Provisional application No. 61/451,391, filed on Mar. 10, 2011.

(51) Int. Cl. B01J 39/04; B29C 35/08; B29C 35/02

(52) U.S. Cl. CPC B01J 39/04; B29C 35/02; B29C 35/0805
USPC 252/184; 264/45.3; 264/460; 210/435; 564/497

(57) ABSTRACT

A filtration media is disclosed comprising functionalized particles distributed throughout a sintered porous matrix, the sintered porous matrix derived from a combination of components comprising first ultra-high molecular weight polyethylene initially comprising a plurality of non-porous particles having a first shape that is substantially spherical; second ultra-high molecular weight polyethylene initially comprising a plurality of non-spherical perforated particles having a second shape that is convoluted; and third ultra-high molecular weight polyethylene initially comprising a plurality of non-spherical perforated particles having a third shape that is convoluted, wherein the functionalized particles comprise a range from about 20% by weight to about 90% by weight of the sintered porous matrix.

### BACKGROUND

In filtration and separation processes, functionalized substrates such as ion exchange resins and adsorbents may be used to remove contaminants from a fluid to achieve a desired effluent quality or level of cleanliness for a specific application. Often, such substrates are provided in loose particulate form and, in use, are packed into a housing to form a column of particulate. A fluid to be conditioned may then be passed through the column to affect the desired separation.

Although simply constructed, such columns can be inefficient. For example, unwanted channels can form along the length of a column, either directly through the packed particulate bed or along the inner walls of the housing. Once formed, these channels can provide flow pathways through the column, and fluids entering the column can be naturally directed along such pathways. As a consequence, the fluid may avoid substantial contact with the bulk of the particulate bed and the effectiveness of the separation process is compromised and rendered inefficient.

Moreover, in such column constructions, particulate beds may compress under the weight of the column and/or differential pressure generated while flowing through the column. Such may be particularly apparent where relatively soft gel-type particulates are employed. Such compression can decrease the porosity and permeability of the particulates to cause increased flow resistance, and, in come cases, reduced separation capacity. To combat such problems, columns may be operated at relatively undesirable low flow rates.

In the particular case of ion exchange functionalized particles, other forms of support have been tried, including immobilization within membranes, as described in U.S. Pat. No. 6,379,551. However, such use of alternative supports for ion exchange resins has not been entirely satisfactory in the removal, for example, of trace impurities (e.g., trace metals) from aqueous and non-aqueous fluids. For example, because such ion exchange membranes typically have a relatively low capacity, they have generally only been useful in applications involving the removal of trace levels of ionic contaminants. Indeed, in some instances such ion exchange membranes may be positioned downstream of a packed ion exchange column as a means to merely polish the already substantially processed fluid to acceptable final levels.

Ion exchange resins have also been immobilized in fibrous filter media structures such as disclosed in U.S. Pat. No. 6,103,122. There, a reported filter sheet can comprise a self-supporting fibrous matrix containing immobilized particle filter aid and particle ion exchange resin. However, the materials used in the construction of such fibrous matrices can themselves be a source of contamination to the fluid stream to be processed. For example, cellulose fibers, diatomaceous earth, perlite, as well as water used in the wetlaid manufacturing process, can be sources of metal impurities that can be detrimental to processes where such impurities are sought to be removed. Moreover, such material combinations tend to be incompatible with high pH fluids or aggressive solvents. Additionally, such constructions may be undesirably limiting in terms of the sizes of functionalized particles that can be successfully immobilized in the fibrous matrix. For example, relatively large particles (in one example, about 400 micrometers or larger) tend to disperse in the matrix in a non-uniform manner and be prone to becoming dislodged from the matrix.

There is a need for improved porous substrates comprising functionalized particles.

### SUMMARY

The invention provides improvements to filtration media in the form of tortuous path filters, to methods of making such filters and to methods for the use of such filters. Filtration media immobilized according to the present disclosure can provide comparable or improved contaminant binding capacity compared to loosely-packed bead columns or other immobilization approaches, while avoiding limitations associated with those approaches. For example, filtration media according to the present disclosure can be advantageously packaged to provide desirable contaminant binding while preventing unwanted fluid channeling and/or media compression.

In a first embodiment, the disclosure provides a filtration media comprising:

functionalized particles distributed throughout a sintered porous matrix, the sintered porous matrix derived from a combination of components comprising:
(i) first ultra-high molecular weight polyethylene, the first ultra-high molecular weight polyethylene initially comprising a plurality of non-porous particles having a first shape that is substantially spherical;
(ii) second ultra-high molecular weight polyethylene, the second ultra-high molecular weight polyethylene initially comprising a plurality of non-spherical perforated particles having a second shape that is convoluted;
(iii) third ultra-high molecular weight polyethylene, the third ultra-high molecular weight polyethylene initially comprising a plurality of non-spherical perforated particles having a third shape that is convoluted; and
wherein the functionalized particles comprise a range from about 20% by weight to about 90% by weight of the sintered porous matrix.

A second embodiment includes the first embodiment wherein the functionalized particles comprise about 50% by weight or more of the sintered porous material, the functionalized particles having an average particle size, when dry, within the range from about 10 microns to about 1200 microns.

A third embodiment includes any of the first or second embodiments wherein the functionalized particles have an average particle size, when dry, within the range from about 400 microns to about 600 microns.

A fourth embodiment includes any of the first through third embodiments wherein the functionalized particles comprise anionic exchange resin.

A fifth embodiment includes any of the first through fourth embodiments wherein the functionalized particles comprise cationic exchange resin.

A sixth embodiment includes any of the first through fifth embodiments wherein the functionalized particles comprise one or more components selected from the group consisting of activated carbons, activated aluminum oxides, zinc based antimicrobial compounds, halogen based antimicrobial compounds, acid gas adsorbents, arsenic reduction materials, iodinated resins, ion exchange resins, metal ion exchange zeolite sorbents, activated aluminas, precipitated silicas, silica gels, metal scavengers, silvers, and combinations of two or more of the foregoing.

A seventh embodiment includes any of the first through sixth embodiments wherein the first ultra-high molecular weight polyethylene initially has a particle size within the range from about 20 microns to about 100 microns; wherein the second ultra-high molecular weight polyethylene initially has a particle size within the range from about 6 microns to about 70 microns; and wherein the third ultra-high molecular weight polyethylene initially has a particle size within the range from about 60 to about 250 microns.

An eighth embodiment includes any of the first through seventh embodiments wherein the first ultra-high molecular weight polyethylene comprises up to about 20% by weight of the sintered porous matrix; the second ultra-high molecular weight polyethylene comprises up to about 20% by weight of the sintered porous matrix; and the third ultra-high molecular weight polyethylene comprises up to about 20% by weight of the sintered porous matrix.

A ninth embodiment includes a filtration media according to any of the first through eighth embodiments and a housing enclosing the filtration media therewithin, the housing comprising a flow inlet to direct a fluid into the housing to the filtration media so that the fluid flows into and through the filtration media for treatment, and a flow outlet to direct fluid exiting from the filtration media out of the housing.

In a tenth embodiment, the disclosure provides a method of making a filtration media, the method comprising:

combining filtration components in a mixture, the mixture comprising:
(i) functionalized particles, the functionalized particles comprising up to about 80% by weight of the mixture,
(ii) first ultra-high molecular weight polyethylene, the first ultra-high molecular weight polyethylene initially comprising a first shape that is substantially spherical and non-porous,
(iii) second ultra-high molecular weight polyethylene, the second ultra-high molecular weight polyethylene initially comprising a plurality of non-spherical particles having a second shape that is convoluted and perforated,
(iv) third ultra-high molecular weight polyethylene, the third ultra-high molecular weight polyethylene initially comprising a plurality of non-spherical particles having a third shape that is convoluted and perforated,

heating the mixture to soften at least one of the first, second or third ultra-high molecular weight polyethylene;

holding the mixture in a predetermined shape during the heating step; and

cooling the mixture to provide the filtration media.

An eleventh embodiment includes the tenth embodiment wherein the functionalized particles comprise about 70% by weight of the mixture, the functionalized particles having an average particle size, when dry, within the range from about 10 microns to about 1200 microns.

A twelfth embodiment includes any of the tenth through eleventh embodiments wherein the functionalized particles have an average particle size, when dry, within the range from about 400 microns to about 600 microns.

A thirteenth embodiment includes any of the tenth through twelfth embodiments wherein the functionalized particles comprise anionic exchange resin.

A fourteenth embodiment includes any of the tenth through thirteenth embodiments wherein the functionalized particles comprise cationic exchange resin.

A fifteenth embodiment includes any of the tenth through fourteenth embodiments wherein the functionalized particles comprise one or more components selected from the group consisting of activated carbons, activated aluminum oxides, zinc based antimicrobial compounds, halogen based antimicrobial compounds, acid gas adsorbents, arsenic reduction materials, iodinated resins, ion exchange resins, metal ion exchange zeolite sorbents, activated aluminas, precipitated silicas, silica gels, metal scavengers, silvers, and combinations of two or more of the foregoing.

A sixteenth embodiment includes any of the tenth through fifteenth embodiments wherein the first ultra-high molecular weight polyethylene has a particle size before heating within the range from about 20 microns to about 100 microns; wherein the second ultra-high molecular weight polyethylene has a particle size before heating within the range from about 6 microns to about 70 microns; and wherein the third ultra-high molecular weight polyethylene has a particle size before heating within the range from about 60 to about 250 microns.

A seventeenth embodiment includes any of the tenth through sixteenth embodiments wherein the first ultra-high molecular weight polyethylene comprises up to about 20% by weight of the sintered porous matrix; the second ultra-high molecular weight polyethylene comprises up to about 20% by weight of the sintered porous matrix; and the third ultra-high molecular weight polyethylene comprises up to about 20% by weight of the sintered porous matrix.

An eighteenth embodiment includes any of the tenth through seventeenth embodiments wherein the first ultra-high molecular weight polyethylene has a bulk density greater than or equal to about 0.4 g/cm³, and an average molecular weight in a range from about 8.0×10⁶ g/mol to about 1.0×10⁷ g/mol.

A nineteenth embodiment includes any of the tenth through eighteenth embodiments wherein the first ultra-high molecular weight polyethylene has an average molecular weight of about 9.2×10⁶ g/mol.

A twentieth embodiment includes any of the tenth through nineteenth embodiments wherein the second ultra-high molecular weight polyethylene has a bulk density less than or equal to 0.25 g/cm³, and an average molecular weight in a range from about 4.0×10⁶ g/mol to about 5.5×10⁶ g/mol.

A twenty-first embodiment includes any of the tenth through twentieth embodiments wherein the second ultra-high molecular weight polyethylene has an average molecular weight of about 4.5×10⁶ g/mol.

A twenty-second embodiment includes any of the tenth through twenty-first embodiments wherein the third ultra-high molecular weight polyethylene has a bulk density less than or equal to 0.33 g/cm³.

A twenty-third embodiment includes any of the tenth through twenty-second embodiments wherein combining filtration components in a mixture comprises:
mixing the functionalized particles, the first ultra-high molecular weight polyethylene, the second ultra-high molecular weight polyethylene, and the third ultra-high molecular weight polyethylene to form the mixture;
impulse filling a mold cavity with the mixture to densify the mixture within the mold cavity;
heating the mold to a temperature sufficient to soften at least one of the first, second or third polyethylene; and
cooling the mold to solidify the softened polyethylene and provide a finished filtration media.

A twenty-fourth embodiment includes any of the tenth through twenty-third embodiments wherein combining filtration components in a mixture comprises:
mixing the functionalized particles, the first ultra-high molecular weight polyethylene, the second ultra-high molecular weight polyethylene, and the third ultra-high molecular weight polyethylene to form the mixture;
filling a mold cavity with the mixture while vibrating the mold to densify the mixture within the mold cavity;
heating the mold to a temperature sufficient to soften at least one of the first, second or third polyethylene; and
cooling the mold to solidify the softened polyethylene and provide a finished filtration media.

A twenty-fifth embodiment includes any of the tenth through twenty-fourth embodiments wherein combining filtration components in a mixture comprises:
mixing the functionalized particles comprising electrically conductive particles, the first ultra-high molecular weight polyethylene, the second ultra-high molecular weight polyethylene, and the third ultra-high molecular weight polyethylene to form the mixture;
filling a mold cavity with the mixture;
subjecting the mixture to a high frequency electromagnetic field to inductively heat the electrically conductive particles to a temperature sufficient to soften at least one of the first, second or third polyethylene; and
cooling the mold to solidify the softened polyethylene and provide a finished filtration media.

A twenty-sixth embodiment includes any of the tenth through twenty-fourth embodiments wherein combining filtration components in a mixture comprises:
mixing the functionalized particles comprising electrically conductive particles, the first ultra-high molecular weight polyethylene, the second ultra-high molecular weight polyethylene, and the third ultra-high molecular weight polyethylene to form the mixture;
advancing the mixture through an extrusion die;
subjecting the advancing mixture to a high frequency electromagnetic field to inductively heat the electrically conductive particles as they advance through the die to a temperature sufficient to soften at least one of the first, second or third polyethylene; and
cooling the extruded mixture to solidify the softened polyethylene and provide a finished filtration media.

In a twenty-seventh embodiment, the disclosure provides a method treating a fluid, comprising:

directing a flow of fluid into and through a filtration media, the fluid comprising contaminants prior to entering the filtration media, the filtration media comprising functionalized particles distributed throughout a sintered porous matrix, the sintered porous matrix derived from a combination of binder components comprising:
(i) first ultra-high molecular weight polyethylene, the first ultra-high molecular weight polyethylene initially comprising a first shape that is substantially spherical and non-porous,
(ii) second ultra-high molecular weight polyethylene, the second ultra-high molecular weight polyethylene initially comprising a plurality of non-spherical particles having a second shape that is convoluted and perforated,
(iii) third ultra-high molecular weight polyethylene, the third ultra-high molecular weight polyethylene initially comprising a plurality of non-spherical particles having a third shape that is convoluted and perforated;

directing the flow of fluid out of the filtration media, the fluid having a reduced contaminant level after passing through the filtration media.

A twenty-eight embodiment includes the twenty-seventh embodiment wherein the contaminants in the fluid prior to entering the filtration media comprise a first level of trace metals and the flow of fluid out of the filtration media comprises a second level of trace metals, the second level being lower than the first level.

A twenty-ninth embodiment includes the twenty-seventh embodiment wherein the fluid comprises an amine solvent, wherein contaminants in the fluid prior to entering the filtration media comprise a first level of heat stable salts and the flow of fluid out of the filtration media comprises a second level of heat stable salts, the second level being lower than the first level.

Filtration media and filters according to the present disclosure may be useful, for example, in the filtration of photoresist compositions and high-purity chemicals as may be used in the electronics manufacturing industry. Filtration of photoresist compositions is generally described, for example, in U.S. Pat. Nos. 6,103,122; 6,576,139; and 6,733,677 to Hou et al., the disclosures of which are hereby incorporated by reference in their entirety. In particular, in column 1, lines 17-36, of Hou et al. '122, it is described that:
Photoresist compositions are used extensively in integrated circuit manufacture. Such compositions typically comprise a light-sensitive component and a polymer binder dissolved in a polar organic solvent. Typical photoresist compositions are disclosed in U.S. Pat. Nos. 5,178,986, 5,212,046, 5,216,111 and 5,238,776, each incorporated herein by reference for disclosure of photoresist compositions, processing and use. Impurity levels in photoresist compositions are becoming an increasingly important concern. Impurity contamination, especially by metals, of photoresists may cause deterioration of the semiconductor devices made with said photoresists, thus shortening these devices' lives. Impurity levels in photoresist compositions have been and are currently controlled by (1) choosing materials for photoresist compositions which meet strict impurity level specifications and (2) carefully controlling the photoresist formulation and processing parameters to avoid the introduction of impurities into the photoresist composition. As photoresist applications become more advanced, tighter impurity specifications must be made.
More particularly, removal of trace metals from a photoresist is generally described in Hou, et al. '122 in column 8, line 19 through column 9, line 34: Photoresists are well known and described in numerous publications including DeForest, Photoresist Materials and Processes, McGraw-Hill Book Company, New York, Chapter 2, 1975 and Moreau, Semiconductor Lithography, Principles, Practices and Materials, Plenum Press, New York, Chapters 2 and 4, 1988, incorporated herein by reference.
Suitable positive-working photoresists typically contain two components, i.e., a light-sensitive compound and a film-forming polymer. The light-sensitive compound undergoes photochemical alteration upon exposure to radiation. Single component systems which employ polymers that undergo chain scission upon exposure to radiation are known. Light-sensitive compounds typically employed in two-component photoresist systems are esters formed from o-quinone diazide sulfonic acids, especially sulfonic acid esters of naphthoquinone diazides. These esters are well known in the art and are described in DeForest, supra, pages 45 47-55, and in Moreau, supra, pages 34-52. Light-sensitive compounds and methods used to make such compounds are disclosed in U.S. Pat. Nos. 3,046,110, 3,046,112, 3,046,119, 3,046,121, 3,106,465, 4,596,763 and 4,588,670, all incorporated herein by reference.
Polymers most frequently employed in combination with positive-working photoresists, e.g., o-quinone diazides, are the alkali soluble phenol formaldehyde resins known as the novolak resins. Photoresist compositions containing such polymers are described in U.S. Pat. Nos. 4,377,631 and 55 4,404,272. As disclosed in U.S. Pat. No. 3,869,292, another class of polymers utilized in combination with light sensitive compounds are homopolymers and copolymers of vinyl phenol. The process of the instant invention is especially useful for the purification of positive-working photoresist compositions, such as the vinyl phenol-containing photoresist compositions.
Negative-working resist compositions can also be purified in accordance with the invention and are well known in the art. Such photoresist compositions typically undergo random crosslinking upon exposure to radiation thereby forming areas of differential solubility. Such rephotoinitiator. Oise [sic] a polymer and a photoinitiator. One class of negative working photoresists comprises, for example, polyvinyl cinnamates as disclosed by R. F. Kelly, Proc. Second Kodak Semin. Micro Miniaturization, Kodak Publication P-89, 1966, p. 31. Other negative-working photoresists include polyvinyl-cinnamate acetates as disclosed in U.S. Pat. No. 2,716,102, azide cyclized rubber as disclosed in U.S. Pat. No. 2,940,853, polymethylmethacrylate/tetraacrylate as disclosed in U.S. Pat. No. 3,149,975, polyimide-methyl methacrylate as disclosed in U.S. Pat. No. 4,180,404 and polyvinyl phenol azide as disclosed in U.S. Pat. No. 4,148,655.
Another class of photoresists for purposes of the invention are those positive and negative acid-hardening resists disclosed in EP Application No. 0 232 972. These photoresists comprise an acid-hardening polymer and a halogenated, organic, photoacid generating compound.
Solvents for photoresists include, but are not limited to, alcohols, e.g., methanol, ethanol, isopropanol, etc.; esters, e.g., acetone, ethyl acetate, ethyl lactate, etc.; cyclic ethers, e.g., tetrahydrofuran, dioxane, etc.; ketones, e.g., acetone, methyl ethyl ketone, etc.; alkylene glycol ethers or esters, e.g., ethylene glycol ethyl ether, ethylene glycol ethyl ether acetate, ethylene glycol dimethyl ether, diethylene glycol dimethyl ether, propylene glycol monomethyl ether acetate, etc.; and the like. Other components typically found in photoresist compositions include colorants, dyes, adhesion promoters, speed enhancers, and surfactants such as non-ionic surfactants.
Essentially every component of a photoresist composition is a potential source of dissolved metallic contaminants that can deleteriously affect performance of an integrated circuit. Typical dissolved metal contaminants include sodium, potassium, iron, copper, chromium, nickel, molybdenum, zinc and mixtures of one or more thereof. Such metal impurities may also be in the form of colloidal particles such as insoluble colloidal iron hydroxides and oxides.

Within the scope of the present disclosure, ionic impurities such as metal cations may be removed from an organic liquid such as a photoresist solution, by, for example, passing the liquid through a disclosed filter to provide a purified photoresist composition. Such processes can result in the reduction of ionic impurities, in some cases down to low parts per billion levels—e.g., single digit levels or even parts per trillion levels—in photoresist compositions.

Additional processes related to processing of photoresist and high purity chemical processes include, for example, U.S. Pat. Nos. 6,610,465; 6,531,267; 5,929,204, the disclosures of which are hereby incorporated by reference in their entirety.

Filtration media and filters according to the present disclosure may also be useful, for example, in the nuclear power industry for radioactive waste clean-up, reactor water clean-up, condensate polishing and polishing of make-up water. Such applications may utilize, for example, ion exchange resins.

Filtration media and filters according to the present disclosure may also be useful, for example, to remove metal catalysts such as palladium, platinum and rhodium from aqueous and organic solvents used in the manufacture of active pharmaceutical ingredients (API). Such application may utilize, for example, activated carbon, ion exchange resins, and/or functionalized silica particles.

Filtration media and filters according to the present disclosure may also be useful, for example, in ion exchange chromatography and affinity chromatography, which are intended to isolate and purify proteins from complex feedstreams such as monoclonal antibody-based pharmaceuticals. Such applications may utilize, for example, ion exchange resins and/or adsorbents.

Filtration media and filters according to the present disclosure may also be useful, for example, to remove ionic contaminants from fluids in order to reduce fluid conductivity, to dehydrate gases, or to remove lipids, fatty acids, surfactants, etc. from fluids used in pharmaceutical and biopharmaceutical applications. Such applications may utilize, for example, adsorbents such as silica gels and precipitated silica particles.

Filtration media and filters according to the present disclosure may also be useful, for example, in the removal of heat stable salts (HSS) from alkanolamine (aka amine) solvents used in natural gas processing plants and oil refineries. In such plants and refineries, amine treatment systems may be used to remove acid gas contaminants from gas and liquid hydrocarbon streams. Amines such as methyldiethanolamine (MDEA), monoethanolamine (MEA) and diethanolamine (DEA) may be used to absorb hydrogen sulfide (H₂S) and carbon dioxide (CO₂) in the contactor. The “rich” amine solution, which may include the H₂S and/or CO₂ contaminants, is then heated in the stripper to separate the acid gas contaminants from the amine. The hot “lean” amine solvent, which no longer contains acid gas, is then cooled and recirculated to the contactor to repeat the process. The acid gas is then further treated for proper disposal.

A common occurrence in such amine treatment systems is the generation of HSS, which are a reaction product of the amine with strong acids such as formic, oxalic, sulfuric or acetic acid. Examples include formates, oxalates, sulfates and acetates. In a specific example, formic acid in the amine solvent could lead to a HSS comprising formate (HSS anion) and a protonated amine molecule (cation). The term “heat stable” is used to describe these salts because the amine is not able to be released when heated in the stripper unlike the salts formed with H₂S and/or CO₂. The HSS can increase in concentration over time leading to operational problems such as reducing the amine effectiveness and capacity since the protonated amine molecules are not available to absorb acid gas in the contactor. HSS can also contribute to corrosion as well as foaming.

Accordingly, immobilizing appropriate functionalized particles—typically anion and/or cation resins—with a polymer binder according to the present disclosure can be useful in the reduction of HSS and provide performance benefits over the same ion exchange resin used in traditional packed beds or columns for reasons described elsewhere in this disclosure.

In some embodiments, the filtration media may be formulated to filter out a broad spectrum of contaminants.

Various terms used herein to describe aspects of the various embodiments of the invention will be understood to have the meaning known to persons of ordinary skill in the art. For clarity, certain terms will be understood to have the meaning set forth herein.

“Convoluted shape,” used in describing the shape of a particle, refers to a complex or intricate surface structure. A convoluted surface may include folds, curves and/or tortuous windings thereon.

“Substantially spherical,” used in describing the shape of a particle, refers to a spherical shape wherein a particle's length along its longest radius is no greater than about 1.5 times the length of its shortest radius.

“Ultra-high molecular weight polyethylene” (UHMW PE) refers to polyethylene having an average molecular weight of about 4×10⁶ grams per mole (g/mole) or greater.

“Bind” or “bound,” used in describing the interaction between a particle and a contaminant, refers to the result of sorbing or chemically reacting with the contaminant by Van der Waals forces, hydrogen bonding, or the like.

“Functionalized,” as used herein to describe a characteristic of substrates, refers to a state wherein a substrate (e.g., any type of insoluble solid or porous matrix, whether in particulate form or otherwise) is configured to bind one or more contaminants.

“Adsorbent” refers to an insoluble porous matrix, typically but not limited to small particles, and preferably with a high internal surface area, that is able to bind soluble contaminants.

“Ion exchange resin” refers to an insoluble matrix (or support structure) normally in the form of small beads fabricated from an organic polymer substrate. The material has a structure of pores on the surface that, upon chemical activation, can comprise exchange sites that trap and release ions.

“Microreticular,” used herein to describe ion exchange resins, refers to ion exchange resins having no permanent pore structure. For example, a microreticular may comprise a cross-linked polymer gel having polymeric chains, wherein a pore structure is defined by varying distances between the polymeric chains. Such gels, whose pore structure is subject to variation based on a number of factors, are commonly referred to as gel-type resins.

“Macroreticular,” used herein to describe ion exchange resins, refers to ion exchange resins comprising one or more agglomerates of microreticulars. Openings or apertures defined between the agglomerates can give macroreticulars an additional porosity beyond that of their constituent microreticulars.

“d10,” used herein to describe particle size distributions, refers to a particle diameter below which the average particle diameters of about ten percent of the particles in a given particle size distribution fall.

“d50,” used herein to describe particle size distributions, refers to a particle diameter below which the average particle diameters of about fifty percent of the particles in a given particle size distribution fall.

“d90,” used herein to describe particle size distributions, refers to a particle diameter below which the average particle diameters of about ninety percent of the particles in a given particle size distribution fall.

As used herein, “a,” “an,” “the,” “at least one,” and “one or more” are used interchangeably. Thus, for example, an article that comprises “a” membrane can be interpreted to mean that the article includes “one or more” membranes.

Also herein, any recitation of a numerical range by endpoints includes all numbers subsumed within that range (e.g., 1 to 5 includes 1, 1.5, 2, 2.75, 3, 3.80, 4, 5, etc.).

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The above summary is not intended to describe all possible embodiments or every implementation of the present invention. Those of ordinary skill in the art will more fully understand the scope of the invention upon consideration of remainder of the description that follows.

### DETAILED DESCRIPTION

Embodiments of the present invention are described herein. In general, the various embodiments provide a filtration media for the treatment of fluids. Methods for the formation of such filtration media and methods for the use thereof are described. The articles of the invention include a filtration media that provides a tortuous path suited for the passage of a fluid therethrough. The filtration media includes functionalized particles maintained within a solid porous matrix derived from a combination of distinct grades of polymeric binder component particles. In some embodiments, the polymeric particles are a combination of three distinct grades of polyolefin particles, and, in some embodiments, the polyolefin particles comprise ultra-high molecular weight (UHMW) polyethylene particulate materials. Methods for making the filtration media described herein provide for a maximum, substantially uniform density of components which are further processed to provide an exceptionally strong porous polymeric matrix having ion exchange resin distributed uniformly throughout the matrix. The filtration media can be assembled with other components to provide products in the form of, for example, a filter cartridge or an encapsulated filter capsule. In its final form, the filtration media can allow a relatively high flow rate therethrough while experiencing a relatively low pressure drop across the media during a filtration operation.

A wide array of functionalized particles are contemplated within the scope of the present disclosure. For example, filtration media or filters according to the present disclosure may comprise, without limitation, one or more of the following alone or in combination: ion exchange resins; adsorbent materials such as but not limited to granular and powdered activated carbon; metal ion exchange zeolite sorbents; activated aluminas; precipitated silica; silica gels; functionalized silica gels; metal scavengers; silver, zinc and halogen based antimicrobial compounds; acid gas adsorbents; arsenic reduction materials; iodinated resins, and the like may be used alone or in any combination depending on the desired application. Disclosed filtration media may be formulated to accommodate the presence of the foregoing functionalized particles and other optional filtering compounds, and the filtration media may be formulated for a specific task such as targeting and removing one contaminant or a group of contaminants from a filtration stream. For example, in some embodiments, the filtration media is used for the removal of trace heavy metals from an aqueous filtration stream.

In certain embodiments, the present invention provides a filtration media made from a plurality of functionalized particles selected, for example, from the list above and a combination of at least three grades of polymer binder components that, when fully processed, form a solid porous filtration media suitable for use in any of a variety of filtration applications. In such embodiments, the polymer binder components comprise distinct forms of UHMW polyethylene particles that include:
(i) First ultra-high molecular weight polyethylene comprising a plurality of non-porous particles having a first substantially spherical shape,
(ii) Second ultra-high molecular weight polyethylene initially comprising a plurality of non-spherical perforated or porous particles having a second convoluted shape, and
(iii) Third ultra-high molecular weight polyethylene initially comprising a plurality of non-spherical perforated or porous particles having a third convoluted shape that is different than the second convoluted shape.

In some embodiments, UHMW polyethylene is desired because it tends to have enhanced mechanical properties compared to other polyethylenes. Such enhanced properties can include, without limitation, abrasion resistance, impact resistance, and toughness. UHMW PE has also been recognized in the electronics industry as a very clean raw material from a metals extraction standpoint for use with, for example, photoresists and high purity chemicals.

In specific embodiments, the polymer components include distinct grades of ultra-high molecular weight (UHMW) polyethylene particles wherein: (i) each grade of polyethylene particle provides an individual morphology that contributes to the surface area, durability, density and porosity of the final filtration media; (ii) the polyethylene particles will soften and adhere to each other and to other materials when heated to a critical temperature; and (iii) the polyethylene particles retain their respective morphologies during processing and are thus recognizable in the finished filtration media.

Polymeric binder materials are selected to create a solid, formed, porous filtration media. Binder materials suitable for use in the various embodiments typically have a very small diameter (e.g., typically less than 1 millimeter) that enhances the inclusion of other filtering materials in the filtration media.

In embodiments utilizing polyolefins as binder materials, suitable materials may be selected from commercially available binder materials. When the binder materials comprise UHMW polyethylene, any of a variety of commercially available UHMW polyethylene particles may be used. For example, suitable UHMW polyethylene include those commercially available under the trademark GUR® through TICONA LLC, Summit, N.J. In at least one embodiment, a suitable form of UHMW polyethylene includes that of grade GUR-4150 which possesses high wear resistance and an average molecular weight (determined by viscometry) of about 9.2 million g/mole. The GUR-4150 particles are substantially spherical with a d10 from about 20 to about 40 microns, a d50 in the range from about 50 to about 70 microns and a d90 in the range from about 80 to about 100 microns. UHMW polyethylene of grade GUR-2126 is also suitable for use in embodiments of the invention in that the polyethylene possesses high wear resistance. The GUR-2126 particles possess a second convoluted shape which may be described as a ‘popcorn-like’ morphology with a d10 from about 6 to about 20 microns, a d50 in the range from about 28 to about 36 microns and a d90 in the range from about 50 to about 70 microns. UHMW polyethylene of grade GUR-2122 is also suitable for use in embodiments of the invention in that the polyethylene possesses high wear resistance, an average molecular weight (determined by viscometry) of about 4.5 million g/mole. The GUR-2122 particles possess a third convoluted shape which may be described as a ‘cauliflower-like’ morphology with a d10 of about 63 microns, a d50 in the range from about 100 to about 140 microns and a d90 of about 250 microns.

Other UHMW polyethylene polymers including particles of larger sizes may be used in filtration media according to the present disclosure. For example, it may be desirable to use either spherical or convoluted UHMW polyethylene polymers, alone or in any combination, having a d50 of about 200 micrometers, about 330 micrometers, or about 450 micrometers. Exemplary polymers include convoluted GUR-4122-5 having a d50 of about 200 micrometers, spherical GUR-4022-6 having a d50 of about 330 micrometers, and convoluted GUR-X-192 having a d50 of about 450 micrometers, also available through TICONA LLC, Summit, N.J.

In some embodiments, two, rather than three, kinds of polymer particles are included in the mixture as binder materials. In such embodiments, various combinations of polymer particles can be used such as spherical/spherical, spherical/convoluted or convoluted/convoluted. In one embodiment, convoluted/convoluted is to provide relatively higher surface area, lower bulk density (weight), and better permeability (flow).

In some embodiments, the foregoing three GUR UHMW polyethylene resins are combined with ion exchange resin(s) and other optional components, as mentioned herein. The foregoing materials are sintered or otherwise thermally processed to bind the polyethylene particles to one another and to bind the polyethylene to ion exchange resin particles as well and thereby provide a single porous filtration media while maintaining the morphologies of the initial polyethylene binder particles.

In ion exchange processes, ions in solution are exchanged with those bound to an insoluble solid. Ion exchange processes have enjoyed numerous applications in industry, research, and medicine including their use in water softening, chromatography, non-aqueous fluid purification, metals reduction and metals recovery, for example. Insoluble solids are used in ion exchange materials such as functionalized porous polymeric materials wherein functional groups are bound to the surfaces and interiors of these materials. The functional groups include an ionic moiety that can exchange with a solvated ion in a fluid stream with which the ion exchange material comes in contact.

Where ion exchange resins are employed, the porous filtration media may include one or more immobilized ion exchange resin(s) within the polymeric binder. Such embodiments are not limited to the use of any specific ion exchange resin or to any specific combinations of resins. In some embodiments, the filtration media may include ion exchange resin in combination with the aforementioned three polymer binder components and other optional components as described herein. A person of ordinary skill in the art will appreciate that suitable functionalized particles, including ion exchange resins, for inclusion in an embodiment of the invention can be selected based, at least in part, on the requirements of an intended filtration application. Ion exchange resins suitable for inclusion in the various embodiments of the invention include cationic resin, anionic resin, mixtures of cationic and anionic resins, chelating, or biologically related ion exchange resins. The ion exchange resins can be, for example, microreticular or macroreticular. In some embodiments, the microreticular type is preferred.

Ion exchange resins that may be included in embodiments of the invention include, but are not limited to, those made of cross-linked polyvinylpyrolidone and polystyrene, and those having ion exchange functional groups such as, but not limited to, halogen ions, sulfonic acid, carboxylic acid, iminodiacetic acid, and tertiary and quaternary amines.

Suitable cation exchange resins may include sulfonated phenolformaldehyde condensates, sulfonated phenol-benzaldehyde condensates, sulfonated styrene-divinyl benzene copolymers, sulfonated methacrylic acid-divinyl benzene copolymers, and other types of sulfonic or carboxylic acid group-containing polymers. It should be noted that cation exchange resins are typically supplied with H+ counter ions, NH4+ counter ions or alkali metal, e.g., K+ and Na+ counter ions. Cation exchange resin utilized herein may possess hydrogen counter ions. An exemplary particulate cation exchange resin is MICROLITE PrCH available from PUROLITE (Bala Cynwyd, Pa.), which is a sulfonated styrenedivinyl benzene copolymer having a H+ counter ion.

Other specific examples of cationic ion exchange resins include, but are not limited to, those available under the following trade designations: AMBERJET™ 1200(H); AMBERLITE® CG-50, IR-120(plus), IR-120 (plus) sodium form, IRC-50, IRC-505, IRC-76, IRC-718, IRN-77 and IR-120; AMBERLYST® 15, 15(wet), 15 (dry), 36(wet); and 50 DOWEX® 50WX2-100, 50WX2-200, 50WX2-400, 50WX4-50, 50WX4-100, 50WX4-200, 50WX4-200R, 50WX4-400, HCR-W2, 50WX8-100, 50WX8-200, 50WX8-400, 650C, MARATHON® C, DR-2030, HCR-S, MSC-1, 88, CCR-3, MR-3, MR-3C, and RETARDION®; PUROFINE PFC100H, PUROLITE NRW100, NRW1000, NRW1100, C100, C145 and MICROLITE PrCH.

Suitable anion exchange resins may include those resins having a hydroxide counter ion whereby hydroxide is introduced during the exchange process. In some embodiments, anion exchange resins comprise quaternary ammonium hydroxide exchange groups chemically bound thereto, e.g., styrene-divinyl benzene copolymers substituted with tetramethylammoniumhydroxide. In one embodiment, the anion exchange resin comprises crosslinked polystyrene substituted with quaternary ammonium hydroxide such as the ion exchange resins sold under the trade names AMBERLYST® A-26-0H by ROHM AND HAAS Company and DOW G51-0H by DOW CHEMICAL COMPANY.

Other specific examples of anionic ion exchange resins include, but are not limited to: AMBERJET™ 4200(CI); AMBERLITE® IRA-67, IRA-400, IRA-400(CI), IRA-410, IRA-900, IRN-78, IRN-748, IRP-64, IRP-69, XAD-4, XAD-7, and XAD-16; AMBERLYST A-21 and A-26 OH; AMBERSORB® 348F, 563, 572 and 575; DOWEX® 1X2-60 100, 1X2-200, 1X2-400, 1X4-50, 1X4-100, 1X4-200, 1X4-400, 1X8-50, 1X8-100, 1X8-200, 1X8-400, 21K CI, 2X8-100, 2X8-200, 2X8-400, 22 CI, MARATHON® A, MARATHON® A2, MSA-1, MSA-2, 550A, MARATHON® WBA, and MARATHON® WGR-2; and MERRIFIELD'S peptide resins; PUROLITE A200, A500, A845, NRW400, NRW4000, NRW6000 and MICROLITE PrAOH. A specific example of mixed cationic and anionic resins is AMBERLITE® MB-3A; PUROFINE PFA600, PUROLITE MB400, MB600, NRW37, NRW3240, NRW3260 and NRW3460.

Suitable chelating exchange resins for removing heavy metal ions may comprise polyamines on polystyrene, polyacrylic acid and polyethyleneimine backbones, thiourea on polystryrene backbones, guanidine on polystryrene backbones, dithiocarbamate on a polyethyleneimine backbone, hydroxamic acid on a polyacrylate backbone, mercapto on polystyrene backbones, and cyclic polyamines on polyaddition and polycondensation resins.

Other specific examples of chelating ion exchange resins include, but are not limited to: PUROLITE S108, S910, S930Plus and S950; AMBERLITE IRA-743 and IRC-748.

Specific examples of biologically related resins that can be used in the processes and products of the invention include, but are not limited to, SEPHADEX® CM C-25, CM C-50, DEAE A-25, DEAEA-50, QAEA-25, QAEA-50, SP C-25, and SP C-50.

The foregoing cationic, anionic, mixed cationic and anionic, and biologically related ion exchange resins are commercially available from, for example, SIGMA-ALDRICH CHEMICAL CO., Milwaukee, Wis., or from ROHM AND HAAS, Riverside, N.J., or from PUROLITE, Bala Cynwyd, Pa.

Additional examples of ion exchange resins include, but are not limited to AG-50W-X12, BIO-REX® 70, and CHELEX® 100, all of which are trade names of BIO-RAD, Hercules, Calif.

In the case of heat stable salt (HSS) reduction, certain functionalized particles may be preferred. For example, particles comprising anion exchange resins can be an effective means to reduce the HSS level in the amine solvent. On example is particles used in the AMI-PUR® PLUS anion exchange resin bed system manufactured by ECO-TEC INC. located in Pickering, Ontario Canada. Another example is particles used in the HSSX® PROCESS offered by MPR SERVICES located in Charlotte, N.C. Another example is particles described in U.S. Pat. No. 5,788,864 assigned to MPR SERVICES relating to use of Type II strong base anion exchange resins to remove heat stable salt anions from alkanolamine solutions as well as a means to regenerate the resin. Cation exchange may also be useful or required if there is a high level of strong cations present such as sodium (Na) or potassium (K), which have also been shown to form a HSS with the HSS anions. Although this type of salt may not reduce the amine capacity to absorb acid gases, the presence of the HSS in the system can nevertheless contribute to corrosion or foaming problems, etc.

In the described HSS application, strong base anion (SBA) resins may be preferred due to their salt-splitting capability whereas weak base anion (WBA) resins are not able to split salts. SBA resins can be further classified as Type I or Type II, which differ in the chemicals used in the amination step that form the quaternary ammonium functional group. SBA Type II resins have higher capacities and better regeneration efficiency than the Type I resins due to the nature of their functional groups. The functional groups on all SBA resins are degraded by exposure to high temperature, but Type I resins are slightly more thermally stable than Type II. For HSS applications, both SBA Type I and Type II resins may be suitable. Specific examples for incorporation into filters or filter elements according to the present disclosure include, but are not limited to: AMBERLITE IRA-410 and IRN-78; AMBERLYST A26-OH; DOWEX SAR; PUROLITE A300, A300-OH, A600, A600-OH, NRW-600 and NRW-5010; IONAC ASB-2 and ASB-1-OH.

The foregoing anionic resins are commercially available from, for example, SIGMA-ALDRICH CHEMICAL CO., Milwaukee, Wis., or from The DOW CHEMICAL COMPANY, or from ROHM and HAAS, Philadelphia, Pa., (now owned by Dow), or from PUROLITE, Bala Cynwyd, Pa., or from LANXESS Sybron, Birmingham, N.J.

Functionalized silica particles that may be included in embodiments of the invention include, but are not limited to: PHOSPHONICS METAL SCAVENGERS STA3, SEM26, SPM32, SEA, SPA10 and STMS; SILABOND METAL SCAVENGERS Imidazole, Triaminetetraacedic Acid, Triametetraacetate Sodium Salt, Thiol, Thiourea and Triamine. These are commercially available from, for example, PHOSPHONICS Ltd, Oxford, UK, or from SILICYCLE, Quebec City, Quebec, Canada.

Specific examples of adsorbent particles include, but are not limited to: SYLOID 74, 622, ED 5 and C809, and SYLOJET P600; SIPERNAT 22S, 33, 50S, 303, 2200 and D17. These are commercially available from, for example, W.R. GRACE, Columbia, Md., or EVONIK DEGUSSA GMBH, Hanau, Germany.

Other exemplary functionalized particles are described in U.S. Pat. No. 5,897,779 to Wisted et al., the disclosure of which is incorporated herein by reference in its entirety. In particular, with reference to column 5, lines 18-43 of Wisted, representative examples of functionalized particles that can be incorporated in the filtration media of the present disclosure include those that, by ion exchange, chelation, covalent bond formation, size exclusion, or sorption mechanisms, bind and remove molecules and/or ions from fluids in which they are dissolved or entrained. Particles that undergo chemical reactions including oxidation and/or reduction are a particularly useful class. Representative examples include silico titanates such as IONSIV™ crystalline silico titanate (UOP, Mount Laurel, N.J.), sodium titanate (ALLIED SIGNAL CORP., Chicago, 111.), anion sorbers such as derivatized styrene divinylbenzene (ANEX™ organic anion sorber, SARASEP CORP., Santa Clara, Calif.), cation sorbers such sulfonated styrene divinylbenzene (DIPHONIX™ organic cation sorber, EICHROM INDUSTRIES, Chicago, 111.), inorganic oxides such as silica, alumina, and zirconia, and derivatives thereof. Useful derivatives include polymeric coatings and organic moieties (such as C18 or C8 alkyl 35 chains, chelating ligands, and macrocyclic ligands) that are covalently bonded to an inorganic oxide particle, such as silica. For an overview of such particles and derivatized particles, see, e.g., U.S. Pat. Nos. 5,393,892, 5,334,326, 5,316,679, 5,273,660, 5,244,856, 5,190,661, 5,182,251, 5,179,213, 5,175,110, 5,173,470, 5,120,443, 5,084,430, 5,078,978, 5,071,819, 5,039,419, 4,996,277, 4,975,379, 4,960,882, 4,959,153, 4,952,321, and 4,943,375, the disclosures of which are incorporated herein by reference in their entirety.

Functionalized particles may be provided with average particle sizes, in dry form, in a range from, for example, about 10 micrometers to about 1200 micrometers, including, for example, about 20, 40, 50, 80, 100, 160, 200, 320, 400, 500, 600, 640, 800, and 1000 micrometers along with any range or combination of ranges therein. For example, in certain embodiments, it is preferred to use functionalized particles have an average particle size of about 400 micrometers or greater, even more preferably in a range from about 400 micrometers to about 600 micrometers. In one embodiment, the functionalized particles have an average particle size, in wet form, of about 570 micrometers with a typical particle size in a range from about 425 micrometers to about 710 micrometers which, when dry, may shrink to an average particle size of roughly 500 micrometers. For example, the functionalized particle may comprise ion exchange resin comprising PUROFINE PFC100H resin have an average particle size of about 570 micrometers with a typical particle size, in wet form, in a range from about 425 micrometers to about 710 micrometers, available from PUROLITE, Bala Cynwyd, Pa. In some embodiments, the functionalized particles may be provided in a mono-modal particle size distribution, such that a single average particle size is reported. In other embodiments, functionalized particles may be provided in a multi-modal particle size distribution such that two or more particle size distributions having differing average particle sizes are combined.

Filtration media made with combinations of the foregoing UHMW polyethylene materials may result in a solid porous filtration product having a significantly increased surface area of the particle as compared to a filtration media made from only one of the UHMW polyethylene materials or a combination of only two of the foregoing polyethylene materials. In combining three distinct particle morphologies into a single porous filtration media, the combined morphologies can provide unexpected enhancements to the finished product. For example, in the foregoing embodiments, the inclusion of non-porous, substantially spherical, ultra-high molecular weight polyethylene binder particles provides the filtration media with high strength. Inclusion of a second ultra-high molecular weight polyethylene binder particle provides material having an expanded surface area and irregular shape so that the finished article is somewhat elastic and durable. The second ultra-high molecular weight polyethylene binder has a convoluted shape that permits fluids to flow both through and around the particles. The addition of a third UHMW polyethylene particles having a larger particle size than either the first or second UHMW polymers helps to open the pores of the finished filtration media. The use of a third UHMW particle with a convoluted surface further permits the flow of fluid both through and around the particles. In various embodiments, the third UHMW polyethylene particles generally have a larger average particle size than the second UHMW polyethylene particles and the convoluted morphology of the third UHMW polyethylene is different than that of the second UHMW particles.

Surprisingly, the inclusion of three different distributions of UHMW polyethylene particles in the manufacture of porous filtration media provides improved performance as compared with articles that include, for example, only one or two distinct distributions of binder particles. Where only the non-porous, substantially spherical, first ultra-high molecular weight polyethylene binder particles are used, the resulting filtration media will possess high density but a filter media made solely of the first UHMW polyethylene particles can typically require a higher ratio of polyethylene-to-ion exchange resin, generally in a ratio of about 3:2 by weight because the lower surface area of the spherical particles provide fewer points of contact for adhesion. When compared with, for example, convoluted particles, more spherical material is needed, but the overall lack of contact points between spherical particles or between the spherical polyethylene and the ion exchange resin(s) will often result in a weak part. The addition of two distinct convoluted binder particles, each with their respective particle sizes and convoluted morphologies, provides a finished filter media that acquires enhanced qualities of all three polymeric materials.

Embodiments of the invention include methods for the manufacture of the filtration media. Prior to actually forming the filtration media, one or more of the individual components may need to be processed into a form suitable for use in the making the finished article. Such processing may be required, for example, due to the requirements of the technical application that is contemplated. For example, ion exchange resins may be provided in a wet format that may be dried prior to incorporation into a filtration media according to the present disclosure. As another example, individual polymeric binder components may be screened to further narrow their particle size distributions. In some embodiments, the components may be milled to reduce the mean particle size. The requirements for such processing of the individual components are well within the knowledge of a person of ordinary skill in the art and are not further described herein.

Following preparation of the individual components, a mixture of the components is prepared. In specific embodiments, the mixture comprises at the three polymer binder materials, functionalized particles and other optional components. In various embodiments, the mixture does not require the addition of liquid solvent, and the components are combined in their dry state as particulates or powders. In such a mixture, functionalized particles are typically added to comprise from about 20% to about 90% by weight of the mixture, including, for example, about 25%, 30%, 35%, 40%, 45%, 50%, 55%, 60%, 65%, 70%, 75%, 80%, and 85% by weight and all ranges and combinations of ranges encompassed therein. In some embodiments, functionalized particles are added in amounts from about 40% to about 75% by weight, and in still other embodiments, from about 50% to about 70% by weight. The remainder of the mixture will include the polymeric binder particles, discussed herein, and other optional components.

In embodiments wherein the final filtration media includes no optional components, the polymer binder content is typically in the range from about 80% to about 10% by weight, from about 60% to about 25% by weight, or from about 50% to about 30% by weight. In general, binder is included in a total overall amount to provide a filtration media with a desired amount of ion exchange resin wherein the media will withstand normal handling and the operating environment it is ultimately exposed to in use.

In some embodiments wherein the filtration media is being made from polymer binder components comprising three forms of UHMW polyethylene particles described previously, the component mixture will typically contain functionalized particles and a combination of polymeric binder component particles, the content of the individual binder particles being divided as follows:
(i) about 5% to about 50% by weight of the binder (or about 1% to about 20% by weight of the sintered porous matrix) comprises the first ultra-high molecular weight polyethylene comprising a plurality of non-porous particles having a first substantially spherical shape,
(ii) about 5% to about 50% of the binder (or about 1% to about 20% by weight of the sintered porous matrix) comprises the second ultra-high molecular weight polyethylene initially comprising a plurality of non-spherical perforated or porous particles having a second convoluted shape, and
(iii) about 5% to about 50% of the binder (or about 1% to about 20% by weight of the sintered porous matrix) comprises the third ultra-high molecular weight polyethylene initially comprising a plurality of non-spherical perforated or porous particles having a third convoluted shape that is different than the second convoluted shape.

In some embodiments, the method encompasses sintering of the components in a mold in order to immobilize the functionalized particles within a polymer matrix. Care must be taken in order to ensure that functionalized particles do not decompose during the sintering process. The polymers (e.g., polyolefins) chosen to immobilize the functionalized particles are typically sinterable at temperatures less than a decomposition temperature of the functionalized particles. Decomposition temperatures of some functionalized particles, e.g., specific ion exchange resins, are well known. However, a specific decomposition temperature can also be readily determined by routine experimentation. Aside from knowing the degradation temperature of the functionalized particles, the polymer binder must also first be capable of being sintered by reference to the melt flow index (MFI) of the polymer. Melt flow indices (MFI) of individual polyolefins are well known or can be readily determined by methods known to those of ordinary skill in the art. The sintering temperature of the polymer binder (e.g., the polyolefin mixture) is also needed and the sintering temperatures of a wide variety of polyolefins are known or can be readily determined by routine methods.

The method may utilize vibration of the materials in order to pack the mold cavity prior to sintering. The person of ordinary skill in the art will appreciate that vibration can optimize how the component materials fill a mold cavity without force or deformation of the particles. In such a process, the mold cavity is vibrated while pre-blended component materials are conveyed into the cavity. Typically, the mold cavity is vibrated and filled to capacity with pre-blended component material. The materials within the cavity are sintered by heating the mold cavity to a point where the particle surface of the three polymeric binder materials being to soften (in some embodiments, to at least about 177 degrees Celsius) and, by proximity to one another, become adhered to each other and to other surrounding particles (e.g., ion exchange resin). Following heating, the mold is allowed to cool to ambient temperature. Once the material is cooled, the finished filtration media is self-supporting and may be removed from the mold.

The use of vibration in a molding operation, as previously described, is further disclosed in U.S. Pat. No. 7,112,280, the entire disclosure of which is incorporated herein by reference thereto.

In another embodiment of the invention, the method for the manufacture of the filtration media comprises impulse filling of the mold cavity. Impulse filling has been described previously in, for example, U.S. patent application Ser. No. 11/690,047, Publication No. 2007/0222101, the entire disclosure of which is incorporated by reference herein. Reference to “impulse filling” refers to the application of force to the mold, causing a discrete, substantially vertical displacement that induces movement of at least a portion of the pre-blended component particles in the mold cavity, thus causing the particles to assume a compact orientation in the mold. Impulse filling includes the indirect application of force such as hammer blows to a table to which the mold is clamped and/or impacts to the table from a pneumatic cylinder, as well as direct methods that displace the molds with a series of jarring motions. In some embodiments, the impulse filling comprises a series of discrete displacements (i.e., impulses) applied to the mold. Impulse filling differs from vibration in that there is a period of non-movement or of little movement between the displacements. The period between displacements can be at least 0.5 (in some embodiments, at least 1, 2, 3, 5, or even at least 10) seconds. The displacement applied to the mold has a vertical component. In some embodiments, the vertical component (as opposed to the horizontal component) accounts for a majority (in some embodiments, a substantial majority (>75%), or even nearly all (>90%)) of the molds movement. In one embodiment, the step of impulse filling comprises administering impulses at a rate in the range of 6 to 120 (in some embodiments, 10 to 90, or even 15 to 60) impulses per minute. In a specific embodiment, the rate is about 20 impulses per minute.

Following impulse filling of the mold cavity, the materials are sintered as previously described.

In other embodiments, particularly where the mixture comprises an electrically conductive component, the method for the manufacture of the filtration media may comprise filling a mold cavity using vibratory or impulse techniques as described above followed by application of a high frequency electromagnetic field to the mixture to sinter the mixture. Such sintering by application of a high frequency electromagnetic field is described in U.S. Pat. App. Ser. No. 61/410,222 to Chamyvelumani et al. (now PCT Pub. No. PCT/US2011/058922), the disclosure of which is incorporated by reference herein in its entirety.

In other embodiments, particularly where the mixture comprises an electrically conductive component, the method for the manufacture of the filtration media may comprises continuous or semi-continuous extrusion of the mixture through a die in combination with application of a high frequency electromagnetic field to the mixture to continuously sinter the advancing mixture. Such extrusion-based sintering with application of a high frequency electromagnetic field is described in U.S. Pat. App. Ser. No. 61/410,234 to Chamyvelumani et al. (now PCT Pub. No. PCT/US2011/058920), the disclosure of which is incorporated by reference herein in its entirety.

The filtration media exhibits a complex internal matrix comprised of millions of minute, interconnected, multi-directional pores of varying diameters forming a tortuous path obstacle to the through flow of contaminants in fluids.

In various embodiments, the filtration media includes a combination of polymeric materials having distinct morphologies to create a formed, structural filtration matrix. In addition, the filtration matrix includes one or more filtration materials or compounds that can include, for example, adsorbents, such as but not limited to granular and powdered activated carbon, metal ion exchange zeolite sorbents such as ENGELHARD'S ATS, activated aluminas such as SELECTO SCIENTIFIC'S ALUSIL, ion exchange resins, silver, zinc and halogen based antimicrobial compounds, acid gas adsorbents, arsenic reduction materials, iodinated resins, textile fibers, and other polyethylene polymers. The formation of a structural filtration matrix accommodates the presence of filtering compounds, which may be formulated to a specific task such as targeting one contaminant only or one group of contaminants, such as for example heavy metals; or it may be formulated to filter out a broad spectrum of contaminants from various contaminant groups. The ability to incorporate filtering material of any particle size or any combination thereof into the polymeric matrix enables greater flexibility in formulating a filter to a given task.

### EXAMPLES

Advantages and embodiments of this disclosure are further illustrated by the following examples, but the particular materials and amounts thereof recited in these examples, as well as other conditions and details, should not be construed to unduly limit this invention. In these examples, all percentages, proportions and ratios are by weight unless otherwise indicated.

Table of Abbreviations

| Abbreviation | |
|---|---|
| or Trade | |
| Designation | Description |
| PMX-1 | UHMWPE polymer available under the trade name “GUR |
| | 2126” from TICONA, LLC, Florence, Kentucky |
| PMX-2 | UHMWPE polymer available under the trade name “GUR |
| | 4150-3” from TICONA, LLC, Florence, Kentucky |
| PMX-3 | UHMWPE polymer available under the trade name “GUR |
| | 2122” from TICONA, LLC, Florence, Kentucky |
| PFC100H | Ion exchange resin available under the trade name Purofine |
| | that from THE PUROLITE COMPANY, Bala Cynwyd, |
| | Pennsylvania |

### Mold

A mold was made of aluminum having an inner cylindrical cavity with a length of 9 inches and a diameter of 1.5 inches. A 0.38 inch core pin was positioned coaxially within the cylinder. The cavity had a surface area of approximately 43.96 square inches (283.6 cm²) and a volume of approximately 14.29 in³ (234.16 cm³).

### Example 1

Pre weighed amounts of PMX-1, PMX-2, PMX-3, and PFC100H ion exchange resin beads in dried form, as described in Table 1, were placed in a mixing container operating at about 390 rpm. The mixing process allowed the beads to remain intact, without milling.

TABLE 1

| | | | Functionalized |
|---|---|---|---|
| Polymer - 25% | | | particles - 75% |
| PMX-1 - 3.6% | PMX-2 - 8.9% | PMX-3 - 12.5% | PFC100H - 75% |
| 10 grams | 20 grams | 35 grams | 210 grams (dry) |

The mixture was processed into a homogeneous blend and poured into the mold cavity. As the mold cavity was filled, impulsive energy (45 psi) was applied to the mold to enhance compaction of the mixture within the cavity. The filled mold was placed in an oven set to a temperature of 177° C. and allowed to rest for two hours. The mold was allowed to cool to ambient temperature—about 22° C.—to become a sintered mass. The sintered mass was then ejected from the mold cavity and tested for air porosity, weight, and beam strength.

### Examples 2-9

Pre weighed amounts of PMX-1, PMX-2, PMX-3, and PFC100H ion exchange resin beads, as described in Table 2, were placed in a mixing container operating at about 390 rpm. The mixing process allowed the beads to remain intact, without milling.

TABLE 2

| | PMX-1 | | | Functionalized |
|---|---|---|---|---|
| | (Avg | PMX-2 | PMX-3 | particles |
| | 30 μm) | (Avg 60 μm) | (Avg 120 μm) | (PFC100H) |
| Example #2 | 3.6% | 8.9% | 12.5% | 75% |
| Example #3 | 3.6% | 8.9% | 12.5% | 75% |
| Example #4 | 8.3% | 8.3% | 8.3% | 75% |
| Example #5 | 8.3% | 8.3% | 8.3% | 75% |
| Example #6 | 12.5% | 8.9% | 3.6% | 75% |
| Example #7 | 12.5% | 8.9% | 3.6% | 75% |
| Example #8 | 1.8% | 5.35% | 17.85% | 75% |
| Example #9 | 3.6% | 8.9% | 12.5% | 75% |

The mixture was processed into a homogeneous blend and poured into the mold cavity. As the mold cavity was filled, impulsive energy (45 psi) was applied to the mold to enhance compaction of the mixture within the cavity. The filled mold was placed in an oven set to a temperature of 177° C. and allowed to rest for two hours. The mold was allowed to cool to ambient temperature—about 22° C.—to become a sintered mass. The sintered mass was then ejected from the mold cavity and tested for air porosity, weight, and beam strength.

### Test Methods

### Block Porosity

A porosity measurement of blocks was obtained using a custom made airflow testing device that measured differential pressure across a block as air was supplied within the block at a specific air flow rate. The measured differential pressure was used as a proxy to determine relative porosity of a block such that a higher differential pressure corresponded to a lower block porosity, and vice-versa. A block was placed on a base sample pedestal of the device. The base sample pedestal had a probe at its center to protrude into the center core of block. The probe included two annular conduits: a center conduit to sense the air pressure in the center core; and an annular conduit to supply pressurized air to the center core. A clamping device about equal in size to the pedestal was lowered onto top (opposite) end of the block. The applied clamping force was about 40 psi, which provided a roughly uniform seal at both ends of the block. Surfaces of both the base and the clamp in contact with the block were provided with circular sheets of 70 durometer rubber to assist in sealing.

The annular conduit of the probe supplied pressurized air into the center core at a constant flow rate of 25 standard liters per minute (SLPM). A pressure transducer measured the pressure difference between (i) the pressure sensed at the center conduit of the probe; and (ii) ambient—i.e., the pressure differential across the block. The test instrument included an MKS model 1559A-100L-SV mass flow meter manufactured by MKS INSTRUMENT, INC., Dallas, Tex. having a manually adjustable flow rate in combination with a HEISE PM pressure indicator manufactured by ASHCROFT INC. of Stratford, Conn. that provided a digital display of differential pressure being measured across the block. Measurements were recorded when the displayed pressure value was stabilized.

TABLE 3

| | PMX-1 | PMX-2 | PMX-3 | Function- | Differential |
|---|---|---|---|---|---|
| | (Avg | (Avg | (Avg | alized | Pressure |
| Sample ID | 30 μm) | 60 μm) | 120 μm) | particles | (in H₂O) |
| Example #2 | 3.6% | 8.9% | 12.5% | 75% | 5.05 |
| Example #3 | 3.6% | 8.9% | 12.5% | 75% | 5.66 |
| Example #4 | 8.3% | 8.3% | 8.3% | 75% | 14.45 |
| Example #5 | 8.3% | 8.3% | 8.3% | 75% | 9.40 |
| Example #6 | 12.5% | 8.9% | 3.6% | 75% | 22.45 |
| Example #7 | 12.5% | 8.9% | 3.6% | 75% | 28.95 |
| Example #8 | 1.8% | 5.35% | 17.85% | 75% | 6.28 |
| Example #9 | 3.6% | 8.9% | 12.5% | 75% | 15.55 |

As summarized in Table 3, composite blocks made with higher percentage of coarse size polymer than finer size polymer generally provided lower differential pressure values (and therefore higher porosities) than composite blocks made with higher percentage of finer size polymer than coarse size polymer. While not wanting to be bound by theory, it is presumed that the coarser polymer particles allow the formation of a higher population of larger pathways to form within a composite block than a block made with finer polymer particles. The blocks having larger pathways can allow less restrictive air flow than composite with smaller pathways.

### Agitated Soak Metal Challenge Test

One way to evaluate functionality and removal capacity of a subject block and each of the block's individual functional components is by a soak test as defined herein.

After the molded blocks were tested for their porosity properties as described above, blocks to be used for performance testing were cut into smaller segments to be soaked as described below. These smaller segments had an outer diameter of about 1.45 inches, an inner diameter of about 0.38 inches, and a length of about 2.30 inches.

A block segment or an individual block component, as summarized Table 4 below, was placed in 500 milliliters of spiked Propylene Glycol Monomethyl Ether Acetate (PGMEA) obtained from TARR CHEMICAL of Phoenix, Ariz. Each soaking material was placed in a 500 milliliter NALGENE brand polymenthylpentene container with a polypropylene cap, the container and cap being obtained from THERMO FISHER SCIENTIFIC of Waltham, Mass.

The PGMEA was spiked with PLASMACAL standards of calcium (Ca), potassium (K) and sodium (Na) targeted to levels of about 5 parts per million for each metal, for a target total of about 15 parts per million. PLASMACAL standards were obtained from SCP SCIENCE of Baie D'urfé, Quebec, Canada. The actual initial trace metal concentrations varied among tests. However, such variation was, in most cases, inconsequential because the capacity per gram determination in Table 4 did not depend on the absolute level of trace metal initially present in the influent.

All sample containers were stacked for a period of twenty-four hours atop a LAB LINE (LAB LINE INSTRUMENTS, INC., Maharashtra, India) 3520 ORBIT SHAKER being agitated at a rate of 100 revolutions per minute. Starting at the sixteenth hour and every other hour thereafter, two 10 milliliter fluid samples were extracted from each container using either a disposable pipette or, if there were any noticeable suspended particulates in the fluid, a syringe filter. Where used, the syringe filter used was a PALL ACRODISC 32 mm syringe filter with 1.2 micron SUPOR® Membrane. Collected samples were placed in refrigeration until it was time for samples to be analyzed for metal contents.

Analyses for all the collected samples were performed using either an Inductively Coupled Plasma Atomic Emission Spectroscopy (ICP-AES) with a CETAR TECHNOLOGIES (Omaha, Nebr.) U6000A Ultrasonic Nebulizer and Membrane Desolvator instruments or a PERKIN ELMER INSTRUMENT (Shelton, Conn.) AANLYST 600 Graphite Furnace Atomic Absorption Spectrometer.

The influent, before soaking, was measured to obtain an initial metal concentration of metal. After agitated soak, the effluent was measured to obtain a post-soak metal concentration. The difference between the initial and post-soak metal concentrations was then compared to the mass of the soaked component to calculate the binding capacity of each soaked component—i.e., the mass of metal bound for each unit of mass of soaked component.

TABLE 4
24-hr Agitated Soak Capacity of Components in Spiked PGMEA

| | Ca | Ca | K | K | Na | Na |
|---|---|---|---|---|---|---|
| | mg/g | mg/g | mg/g | mg/g | mg/g | mg/g |
| PHC100H | 0.0478 | 0.0471 | 0.0524 | 0.0522 | 0.0520 | 0.0513 |
| IX resin | | | | | | |
| Polymer | 0.0160 | 0.0160 | 0.0304 | 0.0304 | 0.0103 | 0.0103 |
| Blend #1 | | | | | | |
| Calculated | 0.0399 | 0.0393 | 0.0469 | 0.0468 | 0.0416 | 0.0411 |
| resin + | | | | | | |
| Polymer | | | | | | |
| Blend #1 | | | | | | |
| (assuming | | | | | | |
| 75% resin | | | | | | |
| and 25% | | | | | | |
| Polymer | | | | | | |
| Blend #1) | | | | | | |
| Tested | 0.0456 | 0.0457 | 0.0463 | 0.0464 | 0.0427 | 0.0432 |
| resin + | | | | | | |
| Polymer | | | | | | |
| Blend #1 | | | | | | |
| (75% | | | | | | |
| resin + | | | | | | |
| 25% | | | | | | |
| Polymer | | | | | | |
| Blend #1) | | | | | | |
| Actual | 0.0356 | 0.0369 | 0.0207* | 0.0208* | 0.0458 | 0.0450 |
| Block | | | | | | |
| segment | | | | | | |

Binding capacity for both the functionalized particles and polymer particles was calculated as summarized in Table 4. Both the functionalized particles and the polymer particles demonstrated binding capacity with all three metal ions. The binding characteristic of the polymer blend was a surprise, suggesting the polymer would provide binding capacity supplementary to the functionalized particle bonding functionality.

Table 4 further considers a calculated (theoretical) and tested capacities for the combined components.

It should be noted that the potassium (K) capacities for the “Actual block segment,” denoted with an asterisk above, are artificially low because the influent was initially spiked with only about 2.9 parts per million of potassium. Because the spiked level was significantly lower than the targeted 5 parts per million, the block segments actually consumed all of the potassium in solution before realizing their full capacity.

### Chromatography Column Capacity Test

Columns were filled with 38 grams of PUROFINE PFC100H ion exchange resin that was purchased from THE PUROLITE COMPANY of Bala Cynwyd, Pa. The 38 grams is equivalent to the amount of resin in a 50 grams composite ion exchange block containing 75 percent of the PUROFINE PFC100H ion exchange resin used in the dynamic metal challenge testing. Two column sizes were used as part of the comparative testing: (1) a narrow column having an inner diameter of about 0.90 inches that was packed with resin to a height of about 4.1 inches; and (2) a wide column having an inner diameter of about 1.35 inches that was packed with resin to a height of about 1.7 inches.

Glass fiber was packed on top of the resin beads to restrain them from excessive movement. Propylene Glycol Monomethyl Ether Acetate (PGMEA) obtained from TARR CHEMICAL of Phoenix, Ariz. was spiked with PLASMACAL standards of calcium (Ca), potassium (K) and sodium (Na) targeted to levels of about 5 parts per million for each metal, for a target total of about 15 parts per million. PLASMACAL standards were obtained from SCP SCIENCE of Baie D'urfé, Quebec, Canada. The actual initial trace metal concentrations varied among tests. However, such variation was inconsequential because the capacity per gram determination in Table 5 did not depend on the absolute level of trace metal initially present in the influent.

The spiked PGMEA was flowed through each column at flow rates of about either 42 or 420 milliliters per minute. These flows were obtained by flowing filtered pressurized air into a 2-litre plastic vessel containing a 1-litre volume of spiked PGMEA fluid. The air was filtered through a 0.2 micron rated PTFE membrane filter obtained from 3M PURIFICATION INC of Meriden, Conn.

Pressurized air forced the fluid in the vessel to exit through one-quarter inch inner diameter polyamide tubing connected to the vessel outlet, the other end of which was connected to the column inlet to feed the fluid into the column.

For the narrow column, the 42 milliliter per minute flow rate was obtained by adjusting the air pressure to about 1.1 psig, while the 420 milliliter per minute flow rate was obtained by adjusting the air pressure to about 10.0 psig. For the wide column, the 42 milliliter per minute flow rate was obtained by adjusting the air pressure to about 0.45 psig, while the 420 milliliter per minute flow rate was obtained by adjusting the air pressure to about 1.25 psig.

As the fluid passed through the packed column, a portion of soluble metal ions making contact with the ion exchange resin beads were captured and retained, while remaining soluble metal ions exited as part of the effluent. The effluent fluid was then recirculated through the column multiple times to substantially consume the available capacity of the resin in the column and thus stabilize the metal levels in the effluent.

Analyses were performed using a THERMO FISCHER SCIENTIFIC (Cambridge, UK) iCAP 6500 Inductively Coupled Plasma Atomic Emission Spectroscopy (ICP-AES) with a CETAR TECHNOLOGIES (Omaha, Nebr.) U6000A Ultrasonic Nebulizer and Membrane Desolvator instruments.

Prior to flowing influent fluid through the column, the influent was sampled to measure its initial metal concentration. Then, after each recirculation, two 10 milliliter effluent samples were collected for each column. The samples were placed in refrigeration until it was time to analyze samples for metal contents. The difference between the influent and effluent metal concentrations was then compared to the mass of the resin in the column to calculate the binding capacity of the resin—i.e., the mass of metal bound for each unit of mass of resin.

TABLE 5
Dynamic Capacity of PFC100H Ion Exchange Column filtering Spiked PGMEA

| Column | | | | | | | | |
|---|---|---|---|---|---|---|---|---|
| ID Size | | Time | Ca | Ca | K | K | Na | Na |
| (inch) | Flow Rates | (minute) | mg/g | mg/g | mg/g | mg/g | mg/g | mg/g |
| 0.90 | 42 mL/min | 24 | 0.1148 | 0.1228 | 0.1474 | 0.1541 | 0.1413 | 0.1258 |
| 0.90 | 420 mL/min | 24 | 0.1269 | 0.1244 | 0.1275 | 0.1180 | 0.1281 | 0.1187 |
| 1.35 | 42 mL/min | 24 | 0.1011 | 0.1155 | 0.1129 | 0.1234 | 0.1238 | 0.1171 |
| 1.35 | 420 mL/min | 24 | 0.1300 | 0.1300 | 0.1284 | 0.1278 | 0.1293 | 0.1317 |

As shown in Table 5, ion exchange column results showed binding capacity of the PFC100H ion exchange resin for each of the soluble metals at levels higher than demonstrated in the soak testing of the individual components.

### Dynamic Metal Challenge Test

Performance testing of block filters made according to examples 8 and 9 was done by flowing Propylene Glycol Monomethyl Ether Acetate (PGMEA) spiked with multiple soluble metals of calcium (Ca), potassium (K) and sodium (Na) targeted to levels of about 5 parts per million for each metal, for a target total of about 15 parts per million. PLASMACAL standards were obtained from SCP SCIENCE of Baie D'urfé, Quebec, Canada. The actual initial trace metal concentrations varied among tests. However, such variation was inconsequential because the capacity per gram determination in Table 6 did not depend on the absolute level of trace metal initially present in the influent.

For this test, the blocks typically weighed about 50 grams, about 75% of which was functionalized particles. Here, the functionalized particles were PUROLITE PUROFINE PFC100H ion exchange resin. Ion exchange blocks were encapsulated in 3M Purification Inc. polypropylene disposable filter capsules.

The spiked PGMEA fluid was flowed in the radial direction, outer diameter to inner diameter of the ion exchange block. Fluid was flowed through ion exchange blocks at rates of either 42 or 420 milliliter per minute providing various contact time with ion exchange resin beads. These flows were obtained by flowing filtered pressurized air into a 2-litre plastic vessel containing a 1-litre volume of spiked PGMEA fluid. The air was filtered through a 0.2 micron rated PTFE membrane filter obtained from 3M PURIFICATION INC of Meriden, Conn.

Pressurized air forced the fluid in the vessel to exit through one-quarter inch inner diameter polyamide tubing connected to the vessel outlet, the other end of which was connected to the column inlet to feed the fluid into the column.

The 42 milliliter per minute flow rate was obtained by adjusting the air pressure to about 0.9 psig, while the 420 milliliter per minute flow rate was obtained by adjusting the air pressure to about 3.0 psig.

As the fluid passed through the block, a portion of soluble metal ions making contact with the ion exchange resin beads were captured and retained, while remaining soluble metal ions exited as part of the effluent. The effluent fluid was then recirculated through the block multiple times to substantially consume the available capacity of the resin in the block and thus stabilize the metal levels in the effluent.

Analyses were performed using a THERMO FISCHER SCIENTIFIC (Cambridge, UK) iCAP 6500 Inductively Coupled Plasma Atomic Emission Spectroscopy (ICP-AES) with a CETAR TECHNOLOGIES (Omaha, Nebr.) U6000A Ultrasonic Nebulizer and Membrane Desolvator instruments.

Prior to flowing influent fluid through the block, the influent was sampled to measure its initial metal concentration. Then, after each recirculation, two 10 milliliter effluent samples were collected for each block. The samples were placed in refrigeration until it was time to analyze samples for metal contents. The difference between the influent and effluent metal concentrations was then compared to the mass of the resin in the column to calculate the binding capacity of the resin—i.e., the mass of metal bound for each unit of mass of resin.

TABLE 6
Dynamic Capacity of PFC100H Composite
Block Components in Spiked PGMEA

| | | Example | | | | | |
|---|---|---|---|---|---|---|---|
| | | 8 | 9 | 8 | 9 | 8 | 9 |
| Flow | Time | Ca | Ca | K | K | Na | Na |
| Rates | (minute) | mg/g | mg/g | mg/g | mg/g | mg/g | mg/g |
| 42 | 24 | 0.1004 | 0.0893 | 0.1058 | 0.0889 | 0.1024 | 0.0867 |
| mL/min | | | | | | | |
| 420 | 24 | 0.1014 | 0.1082 | 0.1034 | 0.1114 | 0.1018 | 0.1040 |
| mL/min | | | | | | | |

As presented in Table 6, composite ion exchange blocks showed binding capacity for all soluble metals tested. Block bonding capacity results are higher than those obtained with the soak test of individual components in Table 4. The composite blocks showed higher bonding capacity than the theoretical calculated and actual combined binding capacity of both the PFC100H resin and UHMW polyethylene polymer blend in Table 4.

Various embodiments of the invention have been described in detail. Those of ordinary skill in the art will appreciated that changes, both foreseeable and unforeseen, may be made to the described embodiments without departing from the true spirit and scope of the invention.

1. Filtration media, comprising:
functionalized particles distributed throughout a sintered porous matrix, the sintered porous matrix derived from a combination of components comprising:
(i) first ultra-high molecular weight polyethylene, the first ultra-high molecular weight polyethylene initially comprising a plurality of non-porous particles having a first shape that is substantially spherical;
(ii) second ultra-high molecular weight polyethylene, the second ultra-high molecular weight polyethylene initially comprising a plurality of non-spherical perforated particles having a second shape that is convoluted;
(iii) third ultra-high molecular weight polyethylene, the third ultra-high molecular weight polyethylene initially comprising a plurality of non-spherical perforated particles having a third shape that is convoluted; and
wherein the functionalized particles comprise a range from about 20% by weight to about 90% by weight of the sintered porous matrix.

2. The filtration media of claim 1 wherein the functionalized particles comprise about 50% by weight or more of the sintered porous material, the functionalized particles having an average particle size, when dry, within the range from about 10 microns to about 1200 microns.

3. The filtration media of claim 1 wherein the functionalized particles have an average particle size, when dry, within the range from about 400 microns to about 600 microns.

4. The filtration media of claim 1 wherein the functionalized particles comprise anionic exchange resin.

5. The filtration media of claim 1 wherein the functionalized particles comprise cationic exchange resin.

6. The filtration media of claim 1 wherein the functionalized particles comprise one or more components selected from the group consisting of activated carbons, activated aluminum oxides, zinc based antimicrobial compounds, halogen based antimicrobial compounds, acid gas adsorbents, arsenic reduction materials, iodinated resins, ion exchange resins, metal ion exchange zeolite sorbents, activated aluminas, precipitated silicas, silica gels, metal scavengers, silvers, and combinations of two or more of the foregoing.

7. The filtration media of claim 1 wherein the first ultra-high molecular weight polyethylene initially has a particle size within the range from about 20 microns to about 100 microns; wherein the second ultra-high molecular weight polyethylene initially has a particle size within the range from about 6 microns to about 70 microns; and wherein the third ultra-high molecular weight polyethylene initially has a particle size within the range from about 60 to about 250 microns.

8. The filtration media of claim 1 wherein the first ultra-high molecular weight polyethylene comprises up to about 20% by weight of the sintered porous matrix; the second ultra-high molecular weight polyethylene comprises up to about 20% by weight of the sintered porous matrix; and the third ultra-high molecular weight polyethylene comprises up to about 20% by weight of the sintered porous matrix.

9. A filter comprising:
filtration media according to claim 1; and
a housing enclosing the filtration media therewithin, the housing comprising a flow inlet to direct a fluid into the housing to the filtration media so that the fluid flows into and through the filtration media for treatment, and a flow outlet to direct fluid exiting from the filtration media out of the housing.

10. A method of making a filtration media, the method comprising:
combining filtration components in a mixture, the mixture comprising:
(i) functionalized particles, the functionalized particles comprising up to about 80% by weight of the mixture,
(ii) first ultra-high molecular weight polyethylene, the first ultra-high molecular weight polyethylene initially comprising a first shape that is substantially spherical and non-porous,
(iii) second ultra-high molecular weight polyethylene, the second ultra-high molecular weight polyethylene initially comprising a plurality of non-spherical particles having a second shape that is convoluted and perforated,
(iv) third ultra-high molecular weight polyethylene, the third ultra-high molecular weight polyethylene initially comprising a plurality of non-spherical particles having a third shape that is convoluted and perforated,
heating the mixture to soften at least one of the first, second or third ultra-high molecular weight polyethylene;
holding the mixture in a predetermined shape during the heating step; and
cooling the mixture to provide the filtration media.

11. The method of claim 10 wherein the functionalized particles comprise about 70% by weight of the mixture, the functionalized particles having an average particle size, when dry, within the range from about 10 microns to about 1200 microns.

12. The method of claim 10 wherein the functionalized particles have an average particle size, when dry, within the range from about 400 microns to about 600 microns.

13. The method of claim 10 wherein the functionalized particles comprise anionic exchange resin.

14. The method of claim 10 wherein the functionalized particles comprise cationic exchange resin.

15. The method of claim 10 wherein the functionalized particles comprise one or more components selected from the group consisting of activated carbons, activated aluminum oxides, zinc based antimicrobial compounds, halogen based antimicrobial compounds, acid gas adsorbents, arsenic reduction materials, iodinated resins, ion exchange resins, metal ion exchange zeolite sorbents, activated aluminas, precipitated silicas, silica gels, metal scavengers, silvers, and combinations of two or more of the foregoing.

16. The method of claim 10 wherein the first ultra-high molecular weight polyethylene has a particle size before heating within the range from about 20 microns to about 100 microns; wherein the second ultra-high molecular weight polyethylene has a particle size before heating within the range from about 6 microns to about 70 microns; and wherein the third ultra-high molecular weight polyethylene has a particle size before heating within the range from about 60 to about 250 microns.

17. The method of claim 10 wherein the first ultra-high molecular weight polyethylene comprises up to about 20% by weight of the sintered porous matrix; the second ultra-high molecular weight polyethylene comprises up to about 20% by weight of the sintered porous matrix; and the third ultra-high molecular weight polyethylene comprises up to about 20% by weight of the sintered porous matrix.

18. The method of claim 10 wherein the first ultra-high molecular weight polyethylene has a bulk density greater than or equal to about 0.4 g/cm³, and an average molecular weight in a range from about 8.0×10⁶ g/mol to about 1.0×10⁷ g/mol.

19. The method of claim 10 wherein the first ultra-high molecular weight polyethylene has an average molecular weight of about 9.2×10⁶ g/mol.

20. The method of claim 10 wherein the second ultra-high molecular weight polyethylene has a bulk density less than or equal to 0.25 g/cm³, and an average molecular weight in a range from about 4.0×10⁶ g/mol to about 5.5×10⁶ g/mol.

21. The method of claim 10 wherein the second ultra-high molecular weight polyethylene has an average molecular weight of about 4.5×10⁶ g/mol.

22. The method of claim 10 wherein the third ultra-high molecular weight polyethylene has a bulk density less than or equal to 0.33 g/cm³.

23. The method of claim 10 wherein combining filtration components in a mixture comprises:
mixing the functionalized particles, the first ultra-high molecular weight polyethylene, the second ultra-high molecular weight polyethylene, and the third ultra-high molecular weight polyethylene to form the mixture;
impulse filling a mold cavity with the mixture to densify the mixture within the mold cavity;
heating the mold to a temperature sufficient to soften at least one of the first, second or third polyethylene; and
cooling the mold to solidify the softened polyethylene and provide a finished filtration media.

24. The method of claim 10 wherein combining filtration components in a mixture comprises:
mixing the functionalized particles, the first ultra-high molecular weight polyethylene, the second ultra-high molecular weight polyethylene, and the third ultra-high molecular weight polyethylene to form the mixture;
filling a mold cavity with the mixture while vibrating the mold to densify the mixture within the mold cavity;
heating the mold to a temperature sufficient to soften at least one of the first, second or third polyethylene; and
cooling the mold to solidify the softened polyethylene and provide a finished filtration media.

25. The method of claim 10 wherein combining filtration components in a mixture comprises:
mixing the functionalized particles comprising electrically conductive particles, the first ultra-high molecular weight polyethylene, the second ultra-high molecular weight polyethylene, and the third ultra-high molecular weight polyethylene to form the mixture;
filling a mold cavity with the mixture;
subjecting the mixture to a high frequency electromagnetic field to inductively heat the electrically conductive particles to a temperature sufficient to soften at least one of the first, second or third polyethylene; and
cooling the mold to solidify the softened polyethylene and provide a finished filtration media.

26. The method of claim 10 wherein combining filtration components in a mixture comprises:
mixing the functionalized particles comprising electrically conductive particles, the first ultra-high molecular weight polyethylene, the second ultra-high molecular weight polyethylene, and the third ultra-high molecular weight polyethylene to form the mixture;
advancing the mixture through an extrusion die;
subjecting the advancing mixture to a high frequency electromagnetic field to inductively heat the electrically conductive particles as they advance through the die to a temperature sufficient to soften at least one of the first, second or third polyethylene; and
cooling the extruded mixture to solidify the softened polyethylene and provide a finished filtration media.

27. A method treating a fluid, comprising:
directing a flow of fluid into and through a filtration media, the fluid comprising contaminants prior to entering the filtration media, the filtration media comprising functionalized particles distributed throughout a sintered porous matrix, the sintered porous matrix derived from a combination of binder components comprising:
(i) first ultra-high molecular weight polyethylene, the first ultra-high molecular weight polyethylene initially comprising a first shape that is substantially spherical and non-porous,
(ii) second ultra-high molecular weight polyethylene, the second ultra-high molecular weight polyethylene initially comprising a plurality of non-spherical particles having a second shape that is convoluted and perforated,
(iii) third ultra-high molecular weight polyethylene, the third ultra-high molecular weight polyethylene initially comprising a plurality of non-spherical particles having a third shape that is convoluted and perforated;
directing the flow of fluid out of the filtration media, the fluid having a reduced contaminant level after passing through the filtration media.

28. The method of claim 27 wherein the contaminants in the fluid prior to entering the filtration media comprise a first level of trace metals and the flow of fluid out of the filtration media comprises a second level of trace metals, the second level being lower than the first level.

29. The method of claim 27 wherein the fluid comprises an amine solvent, and wherein contaminants in the fluid prior to entering the filtration media comprise a first level of heat stable salts and the flow of fluid out of the filtration media comprises a second level of heat stable salts, the second level being lower than the first level.
